(19) United States
(12) Patent Application Publication
(10) Pub. No.: US 2018/0001947 A1
(43) Pub. Date: Jan. 4, 2018

(54) RAILLESS TUGGER TRAIN

(71) Applicant: Helmut-Schmidt-Universität, Hamburg (DE)

(72) Inventors: Rainer Bruns, Hamburg (DE); Stephan Ulrich, Hamburg (DE); Konstantin Krivenkov, Hamburg (DE)

(73) Assignee: Helmut-Schmidt-Universität, Hamburg (DE)

(21) Appl. No.: 15/610,936

(22) Filed: Jun. 1, 2017

(30) Foreign Application Priority Data
Jun. 3, 2016 (EP) 16172789.6

(51) Int. Cl. B62D 59/04; B62D 13/04; B62D 6/00; B62D 53/00; B60S 9/205

(52) U.S. Cl. CPC B62D 59/04; B62D 53/005; B60S 9/205; B62D 6/002; B62D 13/04

(57) ABSTRACT

A railless tugger train (100) includes a train module (10), at least one transportation module and at least two axis modules, wherein each axis module has a stiffly configured axis beam, at which a first mounting device is configured in the form of a stiff mounting of the train module or a transportation module and at which a second mounting device is configured for an articulated connection of a transportation module. At least two wheels (19) are mounted at the axis beam in such a way that the wheels are each rotatable around a rotation axis (D) which is configured vertical to the longitudinal axis (L) of the axis beam.

The present invention relates to a railless tugger train comprising a train module, at least one transportation module and at least two axis modules.

### PRIOR ART

Railless tugger trains can be used in particular as ground conveyors for an in-house transportation. Such a railless tugger train is for example known from EP 2 944 549 A2. The tugger train described there has several transportation modules arranged behind one another, which are pulled by a train module. An axis module is arranged between the train module and the—in driving direction—first transportation module as well as between each of the then following transportation modules. The axis modules each comprise a wheel axle, at which two wheels each are arranged. For connecting the axis modules with the transportation modules or with the train module, two cantilever arms, which are connected to a transportation module or a train module, are arranged at each of the axis modules. These cantilever arms are connected to each other via a pivoting joint approximately centrally along the longitudinal extension of the wheel axle, so that the cantilever arms can be rotated relative to one another. Due to the relative rotatability of the cantilever arms to one another, during a cornering of the tugger train the transportation modules are pivoted relative to the wheel axle, wherein the wheels themselves remain in their position relative to the wheel axle.

However, these pivoting joints transmit all forces acting on the transportation modules during the operation of the tugger train, such as the weight force of the load, the empty weight of the transportation modules, the mass inert forces during accelerating and braking as well as centrifugal forces during cornering, from the transportation modules onto the wheel axle. The pivoting joints between the cantilever arms and the wheel axle therefore have to be able to resist very high strain and additionally have to have a high stiffness. The high stiffness is important, so that no disturbing rolling oscillations occur during the movement of the tugger train. If the connection between the transportation modules and the wheel axle or the axis modules is not stiff enough, in unfavorable load and ground conditions the outer corners of a transportation module might touch ground. A sufficiently solid and stiff design layout and configuration of the pivoting joints and the cantilever arms is technically possible, but it is very complex and leads to high production costs.

### Disclosure of the Invention: Object, Solution, Advantages

It is therefore the object of the invention to provide a railless tugger train which is characterized by a simplified design layout and configuration, simultaneously achieving a solid and stiff connection between the axis modules and the transportation modules.

This object is achieved with the features of the independent claim. Advantageous developments of the invention are defined in the dependent claims.

The invention is characterized in that each axis module has a stiffly configured axis beam, at which a first mounting device is configured in the form of a stiff mounting of the train module or a transportation module and at which a second mounting device is configured for an articulated connection of a transportation module, wherein at least two wheels are mounted at the axis beam in such a way that the wheels are each rotatable around a rotation axis which is configured vertical to the base plane of the axis beam.

According to the invention it is provided that at the axis module, in particular at the axis beam of the axis module, no articulated connection is provided any longer between the train module and the—in driving direction—first transportation module or between two transportation modules arranged behind each other. By this, no longer both transportation modules connected to the axis module or the axis beam of the axis module are rotatable or pivotable relative to the axis beam. Instead, it is now provided that two mounting devices are provided at the axis beam of the axis module, wherein the first of this two mounting devices is configured in such a way that the transportation module to be arranged at the axis beam is fixedly attached to the axis beam and thus a rotationally fixed connection between the axis beam and the transportation module is formed. This first mounting device is preferably configured at the—in driving direction—forward longitudinal side of the axis beam. The cantilever arm of the train module can also be configured as transportation module. A stiff mounting in this case means that the connection between the axis beam and thus the first mounting device and the train module or transportation module is stiff or fixed. Here, the train module or a transportation module can by connected to the first mounting device by a detachable connection, so that a replacement of the train module or transportation module arranged at the first mounting device can be carried out in a fast and easy manner. The detachable connection can be configured, for example, by means of a screw connection. The connection of the train module to the first mounting device of the—in driving direction—first axis module is carried out via a cantilever arm of the train module, so that this cantilever arm is attached to the axis beam in a rotatably fixed manner. In addition to the first mounting device, a second mounting device is configured at the axis beam. This second mounting device is configured in such a way that, in contrast to the first mounting device, an articulated connection of a transportation module to the axis beam is enabled. An articulated connection means that the transportation module connected to the second mounting device or, via the second mounting device, to the axis beam can be pivoted or rotated relative to the axis beam if the tugger train runs on a curved track. The second mounting device can, for example, be configured in the form of a tow coupling. The articulated connection can be configured by a ball joint provided at the second mounting device, by means of which the axis beam can be connected to the transportation module or a cantilever arm of the transportation module. Due to the articulated connection, relative rotations between the transportation module and the axis module or the axis beam of the axis module around all three spatial axes can be enabled, by which can be achieved that the tugger train can compensate uneven ground conditions and can drive on surfaces with differently inclined sections. As an alternative to the configuration of an articulated connection by means of a ball joint, it can also be provided that, for example, a bolt coupling is provided. Such a bolt coupling can enable small rotational movements around the two rotational axes perpendicular to the bolt. Additionally, at least two wheels are mounted at the axis beam in such a way that the wheels are each rotatable around a rotational axis configured vertically to the longitudinal axis of the axis beam. With the tugger train according to the invention, it is therefore provided that the wheels arranged at the axis beam can be rotated or pivoted relative to the axis beam, in order to adjust a steer angle. By this it is possible that the total length of the tugger train can be reduced, with the dimensions of the wheels and the transportation modules as well as the minimal curve radius remaining the same. This can be achieved by the fact that, due to their rotatability, the wheels on the inside of the turn can be inserted into the spaces between the transportation modules in a more space-saving manner than this would be the case in configurations in which the wheels are attached to the axis beam in a rotatably fixed manner and therefore cannot be rotated relative to the axis beam. Due to the possible reduction of the length of the tugger train, it can be achieved that the tugger train driver has to cover only short distances for unloading the load from a transportation module at the destination of the respective load. Due to the configuration according to the invention, it is no longer necessary to provide pivoting joints and therefore to form a solid and stiff design layout and configuration of the pivoting joints. Due to the stiff connection of the transportation module to an axis module each, a particularly stiff connection between the transportation modules and the axis modules can be achieved, so that disturbing rolling oscillations during the movement of the tugger train can be avoided and additionally, the outer corners of the transportation modules can be prevented from touching ground, even in unfavorable load and ground conditions.

The rotational axis of the wheel can be configured outside or inside a contact surface of the wheel. The contact surface of the wheel is the surface, with which the wheel stands or runs on the surface or the ground on which the wheel rolls, stands or drives. If the rotational axis is arranged outside this contact surface, the vertical of the wheel contact surface is spaced apart from the rotational axis, so that the wheel can be pivoted around the rotational axis while being spaced apart from the rotational axis. If the rotational axis is arranged outside the contact surface, the friction surface of the wheel can be reduced, by which the wear of the wheel can be reduced. Additionally, an easier steering of the wheel can be achieved during a halt of the tugger train. If the rotational axis is arranged inside a contact surface of the wheel, the vertical of the wheel contact surface coincides with the rotational axis, so that the rotational axis is located inside the wheel, as a result of which the rotational axis passes through the wheel and the wheel contact surface. If the rotational axis is arranged inside the contact surface of the wheel, it can be achieved that additional roll resistances while driving over obstacles hardly affect the steering of the wheel.

The rotatable mounting of the wheels at the axis beam can, for example, be configured by arranging the wheels at one steering knuckle each, which is mounted at the axis beam and is rotatable around the rotational axis. Here, the wheels are each preferably arranged at the steering knuckles in a rotatably fixed manner, whereas the steering knuckles themselves are rotatably arranged at the axis beam. The rotational axis here runs through the axis beam or the steering knuckles and is therefore spaced apart from the wheels or the vertical of the contact surface of the wheels, so that here the rotational axis of the wheels is located outside the respective wheel contact surface.

The steering knuckles mounted at an axis beam can be individually drivable by means of a steering drive or the steering knuckles mounted at an axis beam can be coupled with each other via a connecting rod and can be conjointly drivable by means of a steering drive. If an individual steering drive is assigned to each steering knuckle, the steering knuckles can be individually driven and controlled, so that also a pivoting or rotating movement of the steering knuckles and thus also a pivoting or rotating movement of the wheels of an axis module can occur independently from each other. As an alternative, it is possible that the steering knuckles arranged at an axis beam are connected with each other via a connecting rod, for example a coupling rod. In this embodiment, the connecting rod is driven and is therefore set in a motion which is transmitted from the connecting rod to the steering knuckles in such a way that the steering knuckles carry out a rotating or pivoting movement. In this embodiment the steering knuckles of an axis module and therefore the wheels of the axis module are jointly driven by means of only one steering drive. The connecting rod can, for example, be driven by means of a cylinder, in particular a hydraulic cylinder, wherein the connecting rod can therefore by moved translationally, wherein this translational movement can be transmitted via a pivoting joint to a crank, wherein the crank can be fixedly connected to a respective steering knuckle, so that the translational movement of the connecting rod can be transferred or transformed into a rotatory movement of the steering knuckles.

As an alternative to the steering knuckles, it can be provided that the wheels are each arranged in an individual center pivot plate retainer or in a fixed castor retainer, which are rotatably mounted at the axis beam. In such an embodiment, the rotational axis for the steering movement of the wheel preferably runs through the center of the wheel contact surface, so that the rotational axis here is located inside the contact surface of the wheel. However, depending on the embodiment of the respective individual center pivot plate retainers or the fixed castor retainers, it can also be provided that the rotational axis run slightly laterally offset to the contact surface of the wheel. In order to achieve a rotational movement of the wheels around their rotational axis and thus relative to the axis beam, a belt pulley can be arranged at each individual center pivot plate retainer or fixed castor retainer, which can be driven by a motor, with a traction mechanism, for example a belt drive, being clamped between the belt pulley and the motor.

The individual center pivot plate retainers or fixed castor retainers mounted at the axis beam can be individually drivable by means of a steering drive or conjointly by means of a steering drive.

The steering drive of both the steering knuckle and the individual center pivot plate retainers or fixed castor retainers can be configured electrically, hydraulically or pneumatically. For example, the steering drive can have an electric motor, a hydraulic or pneumatic motor or an electromagnetic linear drive. Further, the steering drive can have a power controller, which can be configured, for example, in the form of power electronics for an electric motor or an electromagnetic linear drive, or in the form of a valve for hydraulic or pneumatic motors. Further, the steering drive can have a gearing mechanism for transmitting the power of the motor to the wheels or the steering knuckles or the individual center pivot plate retainers or fixed castor retainers. Such a gearing mechanism can serve to transmit the mechanical movement and power generated by the motor to the wheel suspension and thus to the wheels and to adapt same to their needs in size and form. For example, it can be provided that the rotatory movement of an electric motor is converted into a translational movement and thus into a linear movement by means of a spindle drive or a rack-and-pinion drive, and afterwards is transmitted to the wheel suspensions and is converted back into a rotatory movement. For generating a translational movement, hydraulic cylinders can be used. Crank drives are particularly suitable for generating steering movements if the wheels of an axis module are driven conjointly by means of only one steering drive. If an individual steering drive is provided for each wheel of an axis module, it is advantageous to transmit the rotatory movement of the motor directly to the respective wheel suspension and thus to the wheels by means of a pinion gear or a traction drive. For example, the rotatory movement of the electric motors can be transmitted from the motor shafts to the rotational axis of the wheel suspensions by means of cogged-belt drives and can be reduced at the same time. As an alternative to a cogged-belt drive, for example a pinion gear can be used.

In order achieve a particularly good control or adjustment of the operation of the tugger train and thus of the movement of the tugger train, in particular during cornering, it is preferably provided that at least one sensor is arranged at at least one of the axis modules, by means of which data relating to the driving dynamics of the tugger train movement are continuously measurable. This enables a continuous monitoring and control of the tugger train during operation of the tugger train, in order to detect and inhibit building rolling oscillations of the individual transportation modules at an early stage, for example.

Further, it is preferably provided that at least one electronic steering control device is provided at the axis modules, by means of which the current state of movement of the axis modules and thus the steer angles of the wheels to be adjusted by the steering drive are determinable. For this, the electronic steering control device can, for example, use the data relating to the train driving dynamics continuously measured by a sensor. The steering control device additionally contains an adjustment device with which one or several steering drive(s) of the axis module is/are adjusted in such a way that the previously determined steer angles are reached.

Further, it can be provided that at at least one of the axis modules a power supply is arranged, for example to provide power for the operation of an electronic steering control device, a sensor, and/or a motor of a steering drive.

The power supply can be effected for example by arranging at least one connecting device for the power supply connectable to the train module via an electric cable at at least one of the axis modules. Here, the necessary energy can be provided by the train module in electric, pneumatic or hydraulic form and can be transmitted via electric cables, hoses or pipes to the respective connection device at the axis module.

Further, it can also be provided that at least one energy storage device is provided at at least one of the axis modules. The energy storage device can, for example, be a battery, an accumulator and/or a gas pressure storage. In such an embodiment, the necessary energy can be provided from the rotatory movement of the wheels, for example, by means of an electric generator or by means of a hydraulic or pneumatic pump and can be stored in the energy storage device. By this it can be guaranteed that even in a motionless tugger train energy is provided at least temporarily at the individual axis modules.

Further, at at least one of the axis modules at least one hoisting device for hoisting and lowering a transportation module connected to the axis module can be arranged. By means of the hoisting device, the transportation module arranged at the axis module can be hoisted or lowered together with its load, if necessary, which can facilitate the loading and/or unloading of the transportation modules. The hoisting device is preferably arranged in the region of the first and/or second mounting device.

Further, it can be provided that at least one acoustic and/or optic signal transmitter is arranged at at least one of the axis modules. By means of the acoustic and/or optic signal transmitter, for example, a malfunction or a failure of the steering drive(s) and thus the steering of the entire tugger train can be announced to the driver of the tugger train. If a respective signal transmitter is arranged at each axis module, the driver can quickly and easily recognize which steering drive at which axis module is no longer fully operative.

Further, at least one electronic display device can be arranged at at least one of the axis modules. Via this electronic display device, for example in the form of a display, information can be announced to the driver of the tugger train or other persons. In particular, instructions for loading and unloading of the transportation modules can be transmitted by this. Further, for example error messages or information regarding necessary maintenance or repair measures can be displayed via the display device.

Further, at least one input device can be arranged at at least one of the axis modules. By means of the input device, data, information, feedback etc. can be input by the driver or another person in order to store this data or information and retrieve it at a later time, if necessary. Such an input device can, for example, be a keyboard, a touchscreen in combination with an electronic display device, a microphone for speech input and/or a camera for gesture recognition.

Further, an operating data processing unit can be arranged at at least one of the axis modules. Such an operating data processing unit can be configured to register, evaluate and/or store operating data. For registering the operating data of the tugger train operating parameters, such as for example the driving speed, the steer angles, the load mass, acceleration or shocks etc. can be measured continuously or at discrete points in time by sensors present for the steering drive or for a traction drive device as well as by additional sensors. The measured operating parameters can be evaluated in an electronic evaluation unit, such as a micro-controller, and can be condensed to an information and to operating figures. The data identified from this can be locally stored in an electronic storage device and/or can be forwarded to a central evaluation and/or storage device. The transmission of data can be carried out wirelessly by radio, for example by wireless LAN. Alternatively, the transmission of data between the axis modules and between the train module and the axis modules can be carried out via a data cable. The identified operating data can, for example, be used for a stateful maintenance and repair of the tugger train or for an optimization of the logistic processes.

In order to further facilitate the construction of the tugger train and especially to avoid that the brake forces of the tugger train to be applied have to be guided via a chain of the tugger train system, it can be provided that a braking device is arranged at at least one of the axis modules, wherein an individual brake assembly of the braking device can be assigned to each wheel arranged at the axis module.

In order to be able to reduce the traction force to be transmitted from the train module to the individual transportation modules, it can preferably be provided that at least one of the axis modules of the tugger train has a traction drive device. A traction drive device preferably has a motor and a gear mechanism which can adjust the mechanical power of the motor with respect to the rotational speed and the torque and can transmit the same to the wheels of the axis module. The motor can be an electric, a hydraulic or a pneumatic motor.

Here it is preferably provided that an individual traction drive device is assigned to each wheel of an axis module. In such an embodiment each traction drive device drives only one wheel each. For this, for example wheel hub motors can be used. If, however, only one traction drive device per axis module is provided for the wheels arranged at the axis module, the driving power of the motor of the traction drive device is divided between the wheels by a differential gear.

A power supply of the traction drive device or the traction drive devices can be carried out centrally from the train module via energy lines. Alternatively, it can be provided that an individual energy storage device is assigned to each axis module, which serves for the power supply of the traction drive device.

The traction drive device can, for example, be adjustable and/or controllable by means of an electronic drive control device. The drive control devices of the individual axis modules can be coordinated by a superordinate drive control, which, for example, can be located at the train module. For this, a data and/or signal transmission between the axis modules and the train module is necessary. Instead of a central coordination of the individual drive control devices, a decentralized and therefore local control of the traction drive devices of the individual axis modules is also possible. For this, the propelling force to be generated by the respective traction drive device can be adjusted dependent on the traction force introduced by the preceding transportation module or train module. Here, the introduced traction force can be continuously measured and by means of the adjustment control in the drive control device and the traction drive device the propelling force can be adjusted in such a way that the introduced traction force is reduced by a certain factor or limited to a maximum value.

### SHORT DESCRIPTION OF THE DRAWINGS

Further measures improving the invention are shown in more detail in the following together with the description of exemplary embodiments of the invention by means of the figures.

FIG. 1 shows a schematic of a railless tugger train according to the invention,

FIG. 2 shows a view of a sequence of axis modules and transportation modules in different embodiments for a railless tugger train as shown in FIG. 1.

FIG. 3 shows a schematic of an axis module according to the invention for a railless tugger train as shown in FIG. 1,

FIG. 4 shows a schematic of an individual center pivot plate retainer with a wheel arranged thereon according to the invention,

FIG. 5 shows a schematic of a fixed castor retainer with a wheel arranged thereon according to the invention,

FIG. 6 shows a schematic of an axis module according to a further embodiment of the invention for a railless tugger train as shown in FIG. 1,

FIG. 7 shows a further view of the axis module shown in FIG. 6 during a steering movement,

FIG. 8 shows a schematic of an axis module according to a further embodiment of the invention for a railless tugger train as shown in FIG. 1,

FIG. 9 shows a schematic of an axis module according to a further embodiment of the invention for a railless tugger train as shown in FIG. 1,

FIG. 10 shows a schematic of an axis module according to a further embodiment of the invention for a railless tugger train as shown in FIG. 1,

FIG. 11 shows a schematic of an axis module according to a further embodiment of the invention for a railless tugger train as shown in FIG. 1,

FIG. 12 shows a schematic of an individual center pivot plate retainer with a traction drive device arranged thereon and a braking device arranged thereon according to the invention,

### PREFERRED EMBODIMENT OF THE INVENTION

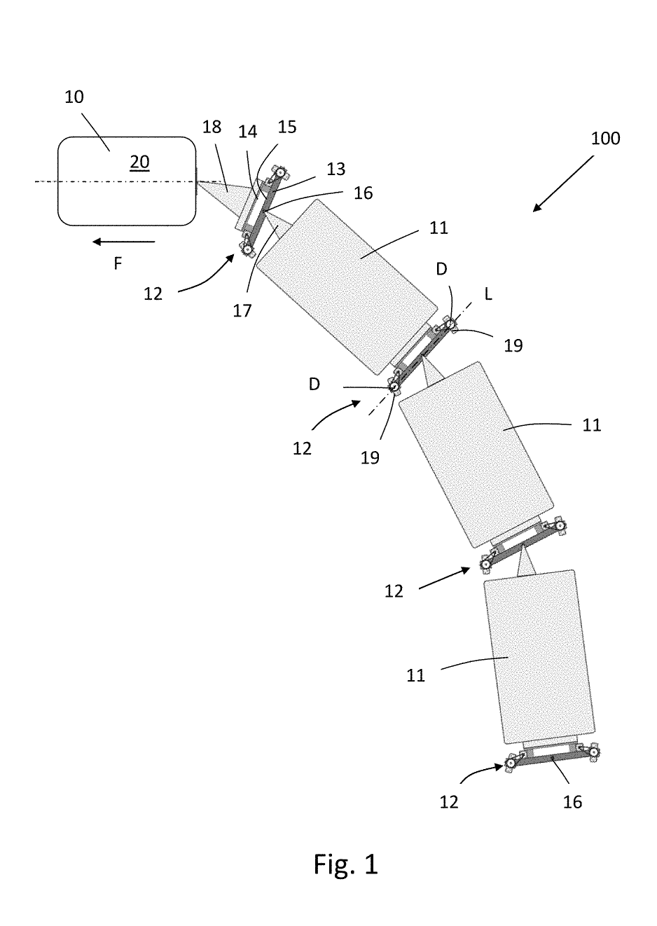

FIG. 1 schematically shows a railless tugger train 100 according to the invention. The railless tugger train has a train module 10, several transportation modules 11 arranged behind one another and several axis modules 12, wherein one axis module 12 each is arranged between two transportation modules 12 arranged behind each other and between the train module 10 and the first—in driving direction F—transportation module 11. Further, an axis module 12 is assigned also to the—in driving direction F—last transportation module 11 as completion of the tugger train 100.

Each axis module 12 has a fixedly configured axis beam 13, which is configured in the form of a rod or a beam.

A first mounting device 14 is configured in the form of a stiff mounting of the train module 10 or a transportation module 11 at each axis beam 13, wherein this first mounting device 14 is preferably configured at the—in driving direction F—forward longitudinal side 15 of the axis beam 13. The train module 10 or one of the transportation modules 11 is arranged at the first mounting device 14 in a rotatably fixed manner, so that a relative movement in the connection area between the axis beam 13 and the train module 10 or the transportation module 11 is avoided.

In addition to the first mounting device 14, a second mounting device 16 is arranged at each axis beam 13, at which an articulated connection of a transportation module 11 is enabled. The second mounting device is configured in the form of a tow coupling. Due to the articulated connection of a transportation module 11 to this second mounting device 16, it can be achieved that the transportation module 11 connected to the second mounting device 16 can be pivoted relative to the axis beam 13 if the tugger train 100 runs on a curved track.

For connecting a transportation module 11 to the second mounting device 16, the transportation module is provided with a cantilever arm 17, which can be directly connected to the second mounting device in an articulated manner.

The connection of the transportation module 11 to the first mounting device 14, however, is carried out without such a cantilever arm.

For connecting the train module 10 to the first mounting device 14, the train module 10 has a cantilever arm 18, wherein this cantilever arm 18 is connected to the first mounting device 14 in a fixed, in particular in a rotatably fixed, manner. To the main body 20 of the train module 10, however, the cantilever arm 18 is connected in an articulated manner.

Two wheels 19 each are mounted at the individual axis beams 13 of the axis modules 12 in such a way that the wheels 19 are each rotatable around a rotation axis D which is configured vertical to the longitudinal axis L of the axis beam 13. During a cornering of the tugger train 100, the wheels 19 can be pivoted relative to the axis beam 13, as shown in FIG. 1.

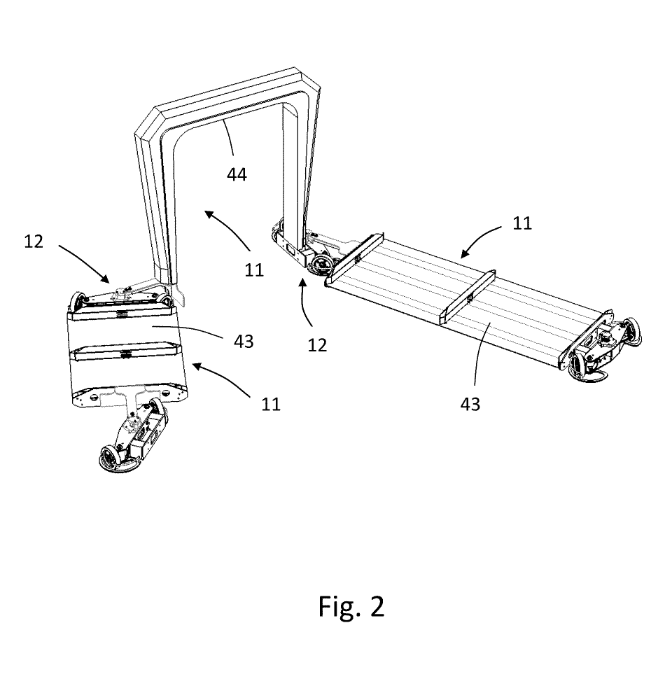

As shown in the following FIGS. 2 to 12, the axis modules 12 and the transportation modules 11 can be configured differently.

FIG. 2 shows a view in which the transportation modules 11 are configured as modules which have a support surface 43 or which have a reception area 44, in which loads can be hung.

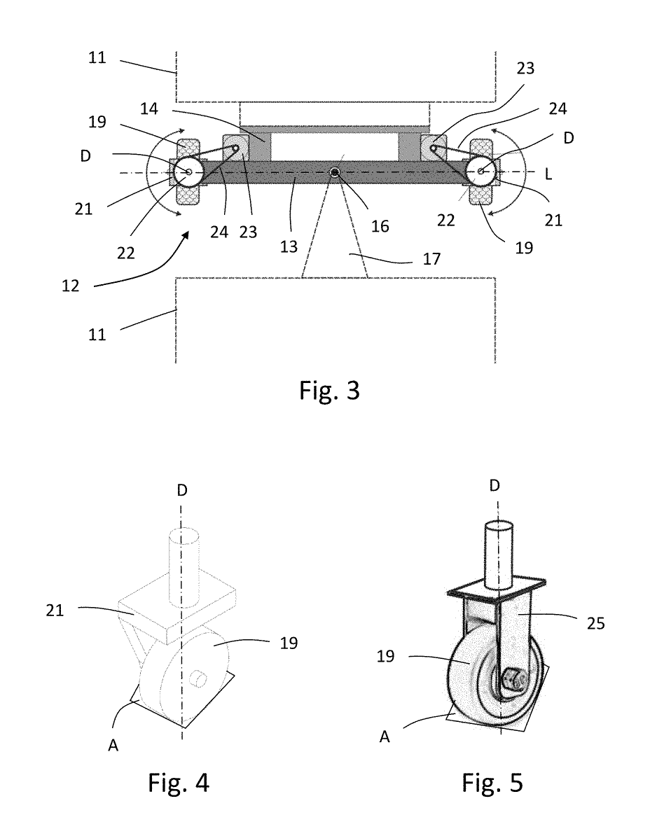

FIG. 3 shows an embodiment of an axis module 12, in which the wheels 19 are each arranged in an individual center pivot plate retainer 21, wherein both individual center pivot plate retainers 21 are each rotatably mounted at the axis beam 13. Due to the rotatable mounting, the wheels 19 are rotatable relative to the axis beam 13. The rotational axis D of the wheels 19, which is configured vertically to the longitudinal axis L of the axis beam 13, directly passes through the wheels 19 and thus through the wheel contact surface A of the wheels 19.

A belt pulley 22 each is arranged at the individual center pivot plate retainers 21, wherein the belt pulleys 22 can be driven by a motor 23, which is connected to the respective belt pulley 22 via a belt drive 24. A belt pulley 22, a motor 23 and a belt drive 24 together form a steering drive, wherein in the embodiment shown in FIG. 3 an individual steering drive in the form of a belt pulley 22, a belt drive 24 and a motor 23 is provided for each individual center pivot plate retainer 21 and thus for each wheel 19.

FIG. 4 shows a respective individual center pivot plate retainer 21 with a wheel 19 arranged at same in detail. Here, it can be seen that in this embodiment the rotational axis D is located inside the wheel contact surface A and thus coincides with the vertical of the wheel contact surface A.

As an alternative to an individual center pivot plate retainer 21, in the embodiment shown in FIG. 3, the wheels 19 can also be arranged in a fixed castor retainer 25 as shown in FIG. 5. In this fixed castor retainer 25, the rotational axis D is also arranged inside the wheel contact surface A, so that the rotational axis D coincides with the vertical of the wheel contact surface A.

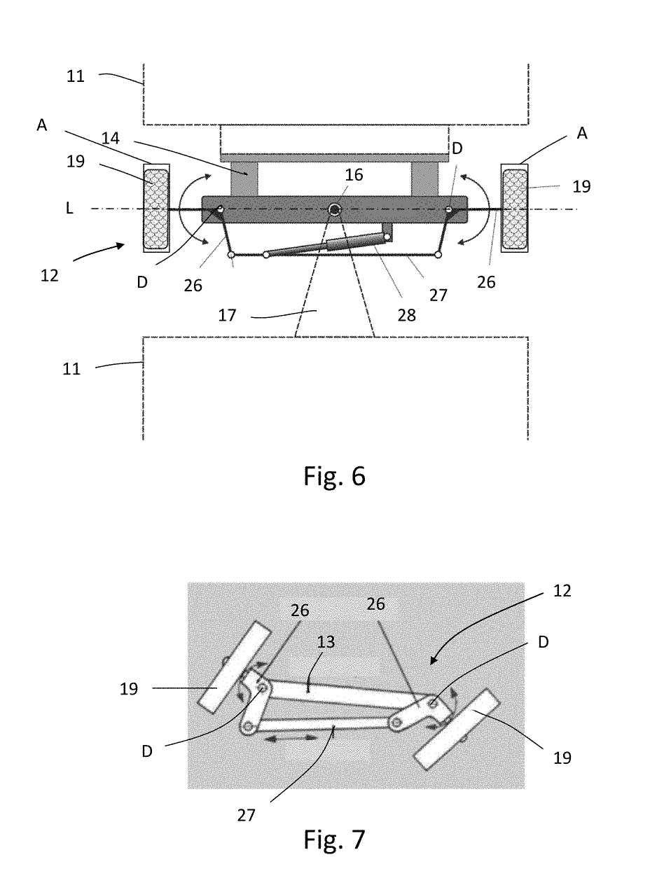

FIG. 6 shows a further embodiment of an axis module 12, wherein in this embodiment, the wheels 19 are each rotatably arranged at a steering knuckle 26 which is arranged at the axis beam 13 and is rotatable around the rotational axis D. In this embodiment, the rotational axis D of the wheel 19 is spaced apart from the respective wheel 19, so that the rotational axis D is located outside a wheel contact surface A of the wheel 19.

The wheels 19 are arranged at the steering knuckles 26 in a rotatably fixed manner. The two steering knuckles 26 are coupled with each other via a connecting rod 27. The steering drive is effected via this connecting rod, with the connecting rod 27 being set in a translational movement via a hydraulic cylinder 28, and this translational movement is transferred or transformed into a rotatory movement of the steering knuckles 26. This is schematically shown particularly in FIG. 7. By this rotatory movement of the steering knuckles 26, a rotational movement of the wheels 19 relative to the axis beam 13 is effected.

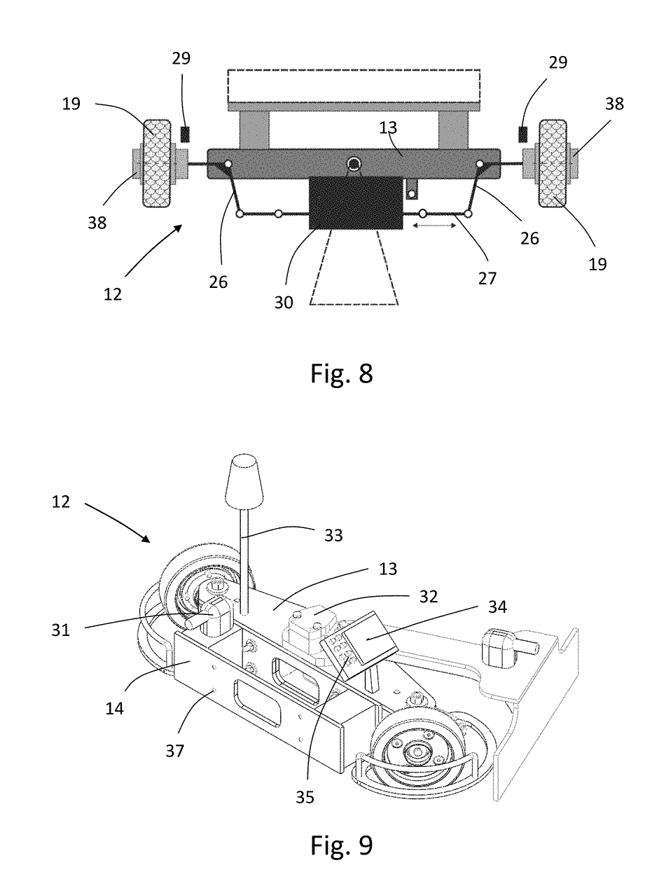

FIG. 8 shows an embodiment of an axis module 12, at which sensors 29 are provided at the axis module 12. The sensors 29 shown here are configured as wheel speed sensors and are positioned in the vicinity to the wheels 19. Further, in this embodiment, no hydraulic cylinder is provided for driving the connecting rod, but a motor 30 which sets the connecting rod 27 in a translational motion in order to achieve a steering of the wheels via the steering knuckles 26. A further sensor in the form of a position sensor can, for example, be arranged at the motor 30. Further, in the embodiment shown in FIG. 8, an individual traction drive device 38 is arranged at each wheel, which here is configured respectively as a wheel hub motor with a gear mechanism.

FIG. 9 shows an embodiment of an axis module 12, in which a connecting device 31 for energy supply, a hoisting device 32, an acoustic and/or optic signal transmitter 33, an electronic display device 34 and an input device 35 are arranged.

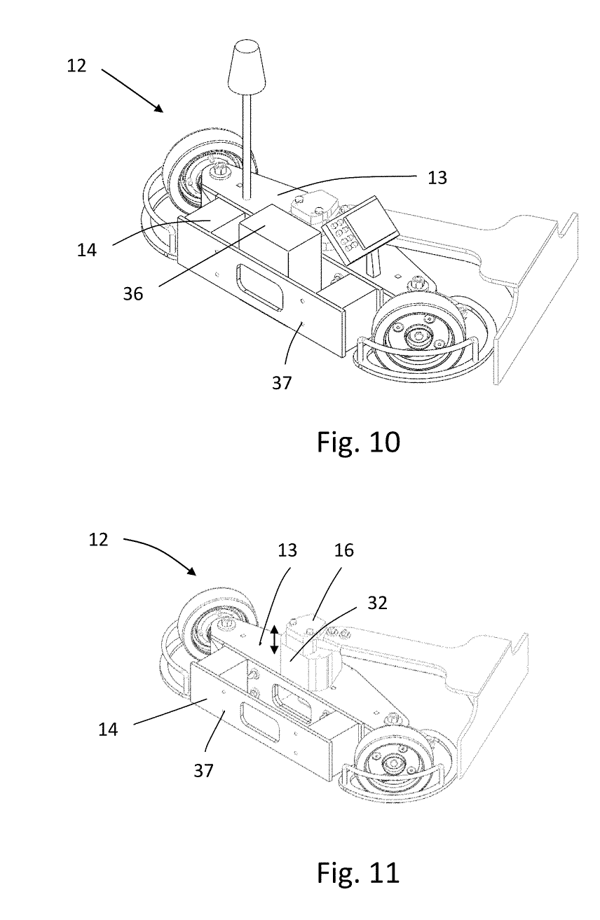

FIG. 10 shows an embodiment, in which an energy storage device 36 is arranged instead of the connecting device for power supply.

In the embodiment of an axis module 12 shown in FIG. 11, the hoisting device 32 is shown in an extended position, in which the transportation module 11 arranged—here not shown—at the second mounting device 16 provided in the region of the hoisting device 32 is hoisted. As schematically indicated in FIG. 11 by the arrow, the hoisting device 32 can be hoisted and lowered in order to achieve an upward and downward movement of the transportation module 11 attached to the second mounting device 16.

As can be seen in FIGS. 9 to 11, the first mounting device 14 has bore holes 37, via which a transportation module 11 or a cantilever arm 18 of a train module 10 can be detachably mounted by means of screws.

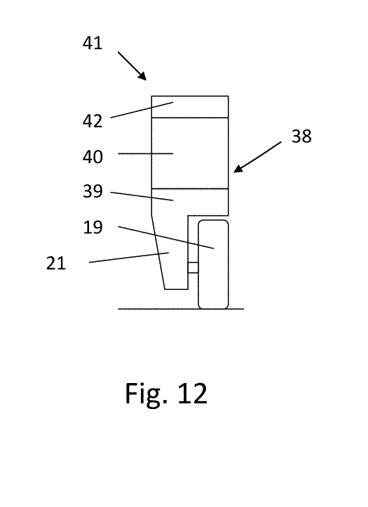

FIG. 12 shows a further embodiment of an individual center pivot plate retainer 21, in which a traction drive device 38 comprising a gear mechanism 39 and a motor 40 is directly arranged at the individual center pivot plate retainer 21. Additionally, a braking device 41 is arranged at the individual center pivot plate retainer 21, which has a brake assembly 42 directly assigned to the wheel 19.

The invention is not limited in its embodiment to the above-described preferred embodiments. Rather, a number of variants are conceivable, which make use of the described solution also for basically different embodiments. All features and/or advantages arising from the claims, the description or the figures, including structural details, spatial arrangements and process steps, can be essential to the invention both by themselves or in arbitrary combinations.

### LIST OF REFERENCE SIGNS

100 tugger train
10 train module
11 transportation module
12 axis module
13 axis beam
14 first mounting device
15 longitudinal side
16 second mounting device
17 cantilever arm
18 cantilever arm
19 wheel
20 main body
21 individual center pivot plate retainer
22 belt pulley
23 motor
24 belt drive
25 fixed castor retainer
26 steering knuckle
27 connecting rod
28 hydraulic cylinder
29 sensor
30 motor
31 connecting device
32 hoisting device
33 signal transmitter
34 display device
35 input device
36 energy storage device
37 bore hole
38 traction drive device
39 gear mechanism
40 motor
41 braking device
42 brake assembly
43 support surface
44 reception area
L longitudinal axis
D rotational axis
A wheel contact surface
F driving direction

1. Railless tugger train with
a train module,
at least one transportation module and
at least two axis modules, characterized in that each axis module has a stiffly configured axis beam, at which a first mounting device is configured in the form of a stiff mounting of the train module or a transportation module and at which a second mounting device is configured for an articulated connection of a transportation module,
wherein at least two wheels are mounted at the axis beam in such a way that the wheels are each rotatable around a rotation axis (D) which is configured vertical to the longitudinal axis (L) of the axis beam.

2. Railless tugger train according to claim 1, characterized in that the rotational axis (D) of the wheel is configured outside or inside a contact surface (A) of the wheel.

3. Railless tugger train according to claim 1 or 2, characterized in that the wheels are each arranged at a steering knuckle which is rotatable around the rotational axis (D) and is mounted at the axis beam.

4. Railless tugger train according to claim 3, characterized in that the steering knuckles mounted at an axis beam are individually drivable by means of a steering drive or that the steering knuckles mounted at an axis beam are coupled with each other via a connecting rod and are conjointly drivable by means of a steering drive.

5. Railless tugger train according to claim 1 or 2, characterized in that wheels are each arranged in an individual center pivot plate retainer or in a fixed castor retainer, which are rotatably mounted at the axis beam.

6. Railless tugger train according to claim 5, characterized in that the individual center pivot plate retainers or fixed castor retainers mounted at an axis beam are individually drivable by means of a steering drive or conjointly by means of a steering drive.

7. Railless tugger train according to claim 4, characterized in that the steering drive is configured electrically, hydraulically or pneumatically.

8. Railless tugger train according to claim 1, characterized in that at least one sensor is arranged at at least one of the axis modules, by means of which data relating to the dynamics of the tugger train (100) movement are continuously measurable.

9. Railless tugger train according to claim 1, characterized in that at least one electronic steering control device is provided at the axis modules, by means of which the current state of movement of the axis module and thus the steer angles of the wheels to be adjusted by the steering drive are determinable, and wherein the steering control device includes an adjustment device with which one or several steering drive(s) of the axis module is/are adjusted in such a way that the previously determined steer angles are reached.

10. Railless tugger train according to claim 1, characterized in that at least one connecting device for a power supply connectable to the train module via an electric line is arranged at at least one of the axis modules.

11. Railless tugger train according to claim 1, characterized in that at least one energy storage device is provided at at least one of the axis modules.

12. Railless tugger train according to claim 1, characterized in that at least one hoisting device for hoisting and lowering a transportation module connected to the axis module is arranged at at least one of the axis modules.

13. Railless tugger train according to claim 1, characterized in that at least one acoustic and/or optic signal transmitter is arranged at at least one of the axis modules.

14. Railless tugger train according to claim 1, characterized in that at least one electronic display device is arranged at at least one of the axis modules.

15. Railless tugger train according to claim 1, characterized in that at least one input device arranged at at least one of the axis modules.

16. Railless tugger train according to claim 1, characterized in that at least one operating data processing unit is arranged at at least one of the axis modules.

17. Railless tugger train according to claim 1, characterized in that a braking device is arranged at at least one of the axis modules, wherein an individual brake assembly of the braking device is assigned to each wheel arranged at the axis module.

18. Railless tugger train according to claim 1, characterized in that at least one of the axis modules has a traction drive device.

19. Railless tugger train according to claim 18, characterized in that an individual traction drive device is assigned to each wheel of an axis module.

20. Railless tugger train according to claim 18, characterized in that the traction drive device is adjustable and/or controllable by means of an electronic drive control device.
